(19) United States
(12) Patent Application Publication
(10) Pub. No.: US 2020/0317958 A1
(43) Pub. Date: Oct. 8, 2020

(54) Sealant Composition

(71) Applicant: PPG Industries Ohio, Inc., Cleveland, OH (US)

(72) Inventors: Charles Jason Albitz, Exton, PA (US); Gregory N. Alexander, Coatesville, PA (US); Michael Coates, Elverson, PA (US); Robert W. Colmery, Elverson, PA (US); Terry Carl Erb, Bechtelville, PA (US); Paul Francis Reginald Ewings, Ripley (GB); Leonard Jonathan Kolle, Pottstown, PA (US); Thomas F. Millea, Morristown, NJ (US)

(73) Assignee: PPG Industries Ohio, Inc., Cleveland, OH (US)

(21) Appl. No.: 16/759,242

(22) PCT Filed: Aug. 3, 2018
(86) PCT No.: PCT/US2018/045154

§ 371 Date: Apr. 24, 2020

(30) Foreign Application Priority Data
Oct. 25, 2017 (GB) 1717562.1

(51) Int. Cl. C09J 7/10; C08G 59/66; C09J 163/10; C09J 9/00

(52) U.S. Cl. CPC C09J 7/10; C08G 59/66; C09J 2203/30; C09J 9/005; C09J 163/10

(57) ABSTRACT

The present invention relates to a kneadable adhesive sealant composition comprising a first outer portion of a first material comprising an uncured reactive polymer or resin composition and a second inner portion of a second material comprising a curing agent capable of curing the uncured reactive polymer or resin composition, wherein the first portion substantially surrounds the second portion and a process for making the same.

### FIELD OF THE INVENTION

The present invention relates to a kneadable adhesive sealant composition and a process for making the same. Kneadable adhesive sealant compositions of this type are useful as adhesives and in the maintenance or repair of surfaces.

### BACKGROUND TO THE INVENTION

Materials that can be cured to harden rapidly at room temperature are of practical use in a variety of industrial and consumer applications, such as sealants and adhesives. One form of sealant that is of interest is the co-extruded epoxy tape, as these offer advantages with ease of use and packaging compared with other forms of sealant.

Known epoxy tapes, such as those disclosed in U.S. Pat. No. 3,837,981, the contents of which are herein incorporated by reference in their entirety, have an elongated portion of uncured epoxy as a ribbon in side-by-side parallel relation with an elongated portion of a curing agent composition. When the two elongated portions of material are mixed to form a uniform mixture, an adhesive sealant is formed which may be applied or used, for example, in adhesive applications or the repair or maintenance of a surface. The adhesive sealant has a putty-like consistency, and when used as an adhesive or sealant has inherent ability to stay where it is applied, even without support or clamping means, to hold objects together during the time required for the curing of the epoxy resin.

Similar fast-curing epoxy tapes are disclosed in G.B. Patent No. 2,097,401, the contents of which are herein incorporated by reference in their entirety.

However, these fast curing co-extruded epoxy tapes have limited shelf stability as they are generally highly air sensitive. Accordingly, there remains a need for fast-curing adhesive sealants, for example epoxy adhesive sealants having improved shelf life and stability.

### SUMMARY OF THE INVENTION

The applicant has developed a novel co-extruded kneadable adhesive sealant composition that has improved shelf life and stability when compared to co-extruded adhesive sealant compositions currently known in the art. This kneadable adhesive sealant composition may be used to form an adhesive sealant, where the adhesive properties of the adhesive sealant are better maintained over time and storage compared with compositions known in the art.

According to a first aspect of the invention, a kneadable adhesive sealant composition, comprises:

a first, outer, longitudinal portion of a first material; and

a second, inner, longitudinal portion of a second material;

wherein the first longitudinal portion substantially surrounds the second longitudinal portion along the length of the second longitudinal portion;

wherein the first material comprises an uncured reactive polymer or resin composition and the second material comprises a curing agent capable of curing the uncured reactive polymer or resin composition; and

wherein, on kneading the composition to form a substantially homogenous mixture, the first and second materials react to cure the polymer or resin composition, and thereby form an adhesive sealant.

The kneadable adhesive sealant composition of the first aspect may advantageously be provided with one or more lateral creases or scores (optionally perforated lateral creases or scores) along the length of the kneadable adhesive sealant composition to divide the kneadable adhesive sealant composition into two or more segments. The creases or scores may be regularly spaced such that each segment has substantially the same shape; or the creases or scores may be irregularly spaced such that more than one shape of segment is present.

In a second aspect of the invention, a kneadable adhesive sealant composition comprises:

one or more, outer, envelopes of a first material; and

a second, inner, material enclosed within the one or more envelopes of the first material surrounded by the first material;

wherein the first material comprises an uncured reactive polymer or resin composition and the second material comprises a curing agent capable of curing the uncured reactive polymer or resin composition; and

wherein, on kneading the composition to form a substantially homogenous mixture, the first and second materials react to cure the polymer or resin composition, and thereby form an adhesive sealant.

The kneadable adhesive sealant composition of the second aspect may be provided as a tape. The kneadable adhesive sealant composition of the second aspect may comprise two or more, outer, envelopes of the first material. Each envelope may have substantially the same shape or more than one shape of envelope may be present.

In a third aspect, the invention provides a process for producing a kneadable adhesive sealant composition, comprising:

providing a first material comprising an uncured reactive polymer or resin composition and a second material comprising a curing agent capable of curing the uncured reactive polymer or resin composition;

co-extruding the first and second materials to form a kneadable adhesive sealant composition, comprising:

a first, outer, longitudinal portion of the first material; and

a second, inner, longitudinal portion of the second material;

wherein the first longitudinal portion substantially surrounds the second longitudinal portion along the length of the second longitudinal portion;

wherein, on kneading the composition to form a substantially homogenous mixture, the first and second materials react to cure the polymer or resin composition, and thereby form an adhesive sealant.

The first and second materials may advantageously be co-extruded through a die having a rectangular cross-section to form a kneadable adhesive sealant composition provided as a tape.

The process may advantageously further comprise the step of making one or more lateral creases or scores along the length of the kneadable adhesive sealant composition, to divide the kneadable adhesive sealant composition into two or more segments according to the first or second aspect of the invention.

In a fourth aspect, the invention provides the use of the kneadable adhesive sealant composition as described herein as an adhesive and/or in the maintenance or repair of a surface, for example a stone, ceramic, metal, wood or plastic surface. The composition is mixed (i.e., kneaded) as described herein to form a substantially homogeneous mixture which may then be applied to the surface or to surfaces to be adhered.

Features discussed herein in relation to the kneadable adhesive sealant composition of the first aspect of the invention apply mutatis mutandis to all other aspects of the invention, including the use and processes described herein.

### DETAILED DESCRIPTION OF THE INVENTION

The present invention provides a kneadable adhesive sealant composition, comprising a first longitudinal portion of a first material; and a second longitudinal portion of a second material.

The first material comprises an uncured reactive polymer or resin composition. The second material comprises a curing agent capable of curing the uncured reactive polymer or resin composition. Such compositions may be air-sensitive, particularly where the compositions are part of fast-curing systems. The present invention aims to improve stability of the precursor composition and may do this by providing protection for the second material. Accordingly, the first portion substantially surrounds the second portion along the length of the second portion so as to provide a protective outer layer.

The invention also provides a kneadable adhesive sealant composition, comprising one or more longitudinal envelopes of a first material and a second material enclosed within the envelope of the first material substantially surrounded by the first material.

An uncured reactive polymer or resin composition may be a composition comprising polymers, pre-polymers and/or monomers that may be polymerised, further polymerised and/or cross-linked to act as an adhesive and/or sealant. In the context of this invention, these processes are generally referred to as “curing”.

The curing agent may be combined with the uncured reactive polymer to form a substantially homogenous mixture, typically by kneading, wherein the first and second materials react to cure the polymer or resin composition, and thereby form an adhesive sealant. For example, the curing agent may be present in an amount sufficient to cure from about 50 to about 150% of the uncured reactive polymer or resin composition. Preferably the curing agent may be present in an amount sufficient to cure from about 75 to about 125%, preferably about 80 to about 120%, preferably about 90 to about 110% preferably about 100%, of the uncured reactive polymer or resin composition. Of course, it will be appreciated that if the agent capable of curing the uncured reactive polymer or resin composition is provided in an amount sufficient to cure over 100% of the uncured reactive polymer or resin composition, it is simply provided in stoichiometric excess.

The first and second materials may be mixed together by any suitable method, but preferably, for convenience, they may be kneaded together by hand or with the aid of mechanical assistance. Thus, the adhesive sealant composition of the invention is kneadable. Mixing allows the first and second material, to react and effect curing, in situ. Accordingly, the kneadable adhesive sealant composition of the invention may be considered a precursor to an adhesive sealant.

An uncured reactive polymer or resin composition for use in the invention may be, for example, an epoxy resin. Epoxy resins are a specific class of reactive pre-polymers and polymers which contain epoxide groups. Epoxy resins may be reacted and/or cross-linked with a wide range of curing agents including polyfunctional amines, acids, acid anhydrides, phenols, alcohols and thiols. These curing agents may be known as hardeners or curatives, and the cross-linking reaction is known as curing. Exemplary epoxy resins that may used in the present invention are described in U.S. Pat. No. 3,837,981 and G.B. Patent No. 2,097,401.

Further examples of reactive polymers or resins which may be used in the composition of the present invention include styrene resins, which may be cured by free radical polymerisation with organo-peroxide curing agents; silicone adhesive resins, which may be cured by moisture sensitive organo-tin crosslinking curing agents; polyisocyanate resins, which may be cured by amine or polyalcohol curing agents; silyl-terminated polyether resins (STPE) cured by polyalcohol or polysilanol curing agents; alkene resins cured by thiol curing agents; acrylic and methacrylic resins cured by amine curing agents; and the like which would be known to those skilled in the art.

The second material comprises one or more curing agents capable of curing the uncured reactive polymer or resin composition by the cross-linking reactions described herein. Exemplary curing agents which may be used to cure, for example, epoxy resins, include polyamides and polymercaptans accelerated with amines. The second material may comprise one or more curing agents capable of polymerising or curing the uncured reactive polymer.

As is known, specific epoxy resins react differently with specific curing agents. One can vary the time required for complete curing of an epoxy resin by varying the specific polyamide curing agents and/or varying the amount of polyamide curing agent. Curing agents which can be expected to provide a fast cure of an epoxy resin, i.e. a cure which is complete within about 10 minutes from the time when the epoxy resin and curing composition are combined to form a substantially homogenous mixture, may comprise liquid polymercaptan polymers and accelerators such as an aminophenol, which undergo such degradation as to progressively lose their ability to cause curing of an epoxy resin as the result of interaction with the atmosphere. A room temperature, fast-cure epoxy resin adhesive sealant may be formulated using solely a polymercaptan as primary curing agent, and curing will be effected within about 5 to about 10 minutes. Adhesive sealants in which curing occurs in 5 minutes or less may be formulated if the curing agent includes accelerators as well as the polymercaptan polymer.

As would be appreciated by a skilled person, the temperature at which curing may be carried out will depend on the particular materials used. Typically, curing is preferably carried out at ambient temperature (i.e., 20° C.±10° C., preferably room temperature, i.e., around 20° C.). Curing times vary, but preferably sufficient curing to form an adhesive sealant will have taken place within about 30 minutes, preferably about 20 minutes, preferably about 10 minutes.

In some instances, particularly rapid cure times (e.g., less than about five minutes) are desired. This may be achieved, for example, by using an epoxy resin and a combination of curing agents, for example a liquid polymercaptan polymer in conjunction with an amine (e.g. an aminophenol). Useful amines are available commercially under the tradename Ancamine® K54 from Evonik (2,4,6-tri(dimethylaminomethyl) phenol). The polymercaptan polymer and aminophenol may be combined in a weight ratio of from about 20:1 to about 4:1, preferably about 20:1 to about 5:1, preferably about 6:1. The polymercaptan or the aminophenol components could, alternatively, be used alone to effect cure of the epoxy resin. Aminophenol curing agents are preferably used only in those levels sufficient to effect room-temperature fast-cure within the desired 10 minute period. This may be accomplished when the agent capable of polymerising or curing the uncured reactive polymer or resin composition contains 5% by weight or less of the aminophenol component.

The polymercaptan polymer and aminophenol fast-cure curing agents are rather low viscosity liquids, and they are air-sensitive compounds as stated above. These components are made useful in an kneadable adhesive sealant compositions of the invention by combining them with components to provide compositions having physical properties required for forming a kneadable, putty-like product. Thus, the agent capable of polymerising or curing the uncured reactive polymer or resin composition may be mixed with various fillers, plasticisers, colorants and other special purpose ingredients. In preferred embodiments, the low-viscosity liquid fast-cure curing agent is combined with a high viscosity polyamide resin or blend of polyamide resin in a weight ratio of about 1:1 to about 10:1, preferably about 1:1 to about 2:1, and with an inert carrier such as talc (i.e., H₂Mg₃(SiO₃)₄), to form a kneadable, putty-like composition which may be extruded.

The first material (comprising the uncured reactive polymer or resin composition) and the second material (comprising the curing agent) may further comprise additional components, for example selected from fillers, plasticisers, and colorants, to form the putty-like compositions which may be extruded to form the longitudinal portions making up the adhesive sealant of the invention. Useful fillers for this purpose include talc and powdered alumina. Fillers such as these provide the uncured reactive polymer or resin composition and the curing agent with physical properties suitable for extrusion into tape form. The fillers are incorporated in amounts sufficient to produce a putty-like mass which can be easily extruded. Powdered talc such as Mistron® Vapor, available commercially from Imerys Talc, is an especially preferred filler, since it yields a handleable putty-like mass comprising an uncured reactive polymer or resin composition and curing agents. Putty-like products prepared with this filler show less tendency to stick to the hands than do compositions prepared with other fillers. Other useful fillers include glass particles (e.g. silicon dioxide microspheres). Useful plasticisers include resinous polyols and other agents which serve to yield a more flexible cured product.

A variety of coloring agents may be included in the first and/or second materials as desired. Useful coloring agents include pigments like titanium dioxide which provides a white color; carbon black for black color and various organic and inorganic pigments for other colors. It is desirable that the respective longitudinal portions of the first material and the second material be of contrasting color, to serve as an indicator of complete and thorough mixing. When, for example, the first and second material bands are of contrasting color, it is easy to determine when a substantially homogeneous mixture has been obtained simply by continuing mixing until the mixture has a uniform color.

Additionally, colourants and dyes that change appearance during the curing reaction can also be used as a further indicator for complete mixing and also reaction. US patent no. 4 160 064, the contents of which are herein incorporated by reference in their entirety, discloses colouring agents, specifically, dyes, that may be combined with an epoxy resin of the present invention and are effective to impart latently transient color to the epoxy resin which contrasts with the colour of the curing agent. The coloured epoxy resin and curing agent form a substantially uniformly coloured mixture when combined and the latently transient colour of the uniformly colored mixture becoming essentially colorless or white with curing of the epoxy resin. Further suitable colouring agents that may be used in the present invention are set out in European patent application no, 2562210, the contents of which are herein incorporated by reference in their entirety.

The kneadable adhesive sealant composition may comprise from about 5 to about 40 wt % of an uncured reactive polymer or resin composition, and about 5 to about 40% of a curing agent. The curing agent should be present in composition in an amount sufficient to cure from about 50 to about 150% of the uncured reactive polymer or resin composition. The kneadable adhesive sealant composition may further comprise up to about 80 wt % filler and/or up to about 25 wt % plasticisers or colourants and/or up to about 5 wt % of an amine.

The relative proportions of the polymer or resin composition and the curing agents can vary widely provided that sufficient amounts of each are present to enable the formation of an adhesive sealant on mixing. By way of example, the kneadable adhesive sealant composition may comprise from about 5 to about 40 wt % of an epoxy resin, about 5 to about 40% of a curing agent, about 20 to about 80 wt % filler, up to about 5 wt % of an amine (e.g., an aminophenol) and up to about 25 wt % plasticisers or colourants, For example, the first material may comprise from about 10 to about 80 wt % of an epoxy resin and about 20 to about 80 wt % filler and up to about 25 wt % plasticisers or colourants. The second material may comprise about 10 to about 80% of a curing agent, about 20 to about 80 wt % filler, up to about 5 wt % of an amine (e.g., an aminophenol) and up to about 25 wt % plasticisers or colourants,

For example, the first material may comprise about 5 to about 80 wt % (for example, about 10 to about 80, preferably about 10 to about 60 wt %) of an epoxy resin (for example, a bisphenol-A-(epichlorohydrin) epoxy resin (having number average molecular weight of 700 Da)), about 25 to about 60 wt % (for example, about 30 to about 60 wt %) talc filler, and up to about 25 wt % silicon dioxide microspheres filler. The second material may comprise about 10 to about 80 wt % (for example, about 10 to about 60 wt %) of an epoxy hardener, about 25 to about 60 wt % (for example, about 30 to about 60 wt %) talc filler, and up to about 25 wt % silicon dioxide microspheres filler and up to about 5 wt % of a phenol (for example, aminophenol or 2,4,6-tris(dimethylaminomethyl)phenol), The first and second materials may further comprise up to about 5 wt % titanium dioxide, up to about 1 wt % 3,6-diaxaoctanethylenediamine and up to about 25 wt % di-isodecyl phthalate.

When the kneadable adhesive sealant composition of this invention is used to form an adhesive sealant, any desired quantity of the composition preferably made of approximately equal lengths/volumes (where the stoichiometry allows) of each longitudinal portion in the composition is selected and kneaded together under ambient conditions forming a homogenous mixture.

As would be appreciated by a skilled person, where the curing agent capable of curing the uncured reactive polymer or resin composition is present in composition in an amount sufficient to cure about 100% of the uncured reactive polymer or resin composition (i.e., with substantially equal stoichiometry's), the volume of each of the first material and the second material per length of the composition may preferably be about equal. This allows substantially equal parts (e.g., lengths/volumes) of the first and second materials to be combined to form the adhesive sealant.

The first longitudinal portion of a first material and/or the second longitudinal portion of a second material may have any suitable cross section, but preferably have a circular or elliptical cross-section. Alternatively, the first longitudinal portion of a first material and/or the second longitudinal portion of a second material may have a square or rectangular cross-section.

The kneadable adhesive sealant composition may be provided in the form of a stick, for example of substantially cylindrical or rectangular shape. Alternatively, the kneadable adhesive sealant composition may be provided in the form of a tape or a sheet.

The kneadable adhesive sealant composition may be surrounded by a protective coating or casing, for example a film. The protective film may be formed from, for example, any suitable plastic or paper material (e.g., silicone-coated polyethylene). As would, be appreciated, if the composition is provided as a tape, flexibility of the composition may be of importance, so the protective film is preferably also flexible. The protective coating or casing is preferably substantially impermeable to air so as to provide protection for the kneadable adhesive sealant composition.

The kneadable adhesive sealant composition may be any convenient dimension for use. The width of the kneadable adhesive sealant composition may preferably be about 2.5 mm to about 50 mm. As would be apparent to a skilled person, the width of the composition is taken perpendicular to the first and second longitudinal portions. Where the kneadable adhesive sealant composition is a stick, the composition may have a width of about 5 to about 50 mm, preferably about 8 to about 40 mm. Where the kneadable adhesive sealant composition is a tape, the composition may have a first width of about 15 to about 25 mm and a second width taken 90° to the first width (i.e., a thickness) of about 2.5 to about 7.5 mm. The first longitudinal portion of a first material and the second longitudinal portion of a second material may each have a cross-section having an area of about 10 mm² to about 1000 mm².

One or more lateral creases or score lines may be provided along the length of the kneadable adhesive sealant composition to aid separation. These creases or score lines may be provided perpendicular to the length of the composition, and divide the kneadable adhesive sealant into two or more segments (which may also be called sachets). The creases or scores should not pass through the full width or cross-section of the kneadable adhesive sealant composition, but leave a thin strip of material between segments that aids easy separation of the segments of the kneadable adhesive sealant composition. Such segments or sachets of the kneadable adhesive sealant composition may be the envelopes of the kneadable adhesive sealant composition according to the second aspect of the invention. This has the benefit of creating pre-portioned unit doses of the compositions which may be selected by a user.

Each unit dose (i.e., each segment or sachet) may advantageously be separated from the bulk kneadable adhesive sealant composition by a user without needing to use tools, such as knives or scissors. Preferably the creases or score lines are such that the individual segments or sachets are easily separated from the bulk material by a user, preferably easily separated by hand. Thus, it is advantageous that the creases or scores are preferably of sufficient dimensions that allow the user to separate each segment of the kneadable adhesive sealant composition by hand, for example simply by tearing the segment from the bulk. Perforation of the creases or scores may provide easier separation of the segments by a user.

The provision of such creases or scores is advantageous to provide separable segments of the kneadable adhesive sealant composition over simply cutting segments of the kneadable adhesive sealant composition using tools, such as a knife, without the provision of the creases or scores. When simply cut by a knife without the provision of the creases or scores, the inner second material is left exposed at the cut ends. This may negatively affect the stability of the kneadable adhesive sealant composition. Where the creases or score lines have been provided, the second material is substantially contained within the first material.

The creases or score lines may be arranged such that the thin strip of material between the segments or sachets is formed from the first material and the second material remains surrounded by the first material. Thus, the creases or score lines may be such that the longitudinal portion of the second material is discontinuous. This has the benefit that each segment of the composition contains the second material substantially sealed within the first material, so when the segments are separated (preferably by hand by the user) the second material remains substantially enclosed within the first material and is not exposed to air. Generally, the agent capable of curing the uncured reactive polymer or resin composition which is provided in the second material is air-sensitive and so the arrangement where the second material is sealed within the first material in each segment provides improved stability for the kneadable adhesive sealant composition. The creases or score lines may form perforated or otherwise weakened strips of material between segments to further aid separation of the segments.

The outer layer of the first material, therefore, may have dual function as it is the uncured reactive polymer or resin composition that is cured to form the adhesive and also functions as a protective layer for the inner second material.

Preferably, these creases or score lines are provided when the kneadable adhesive sealant composition is in the form of a tape. This enables improved storage of the composition as the creases or score lines improve the folding ability of the tape or sheet. Where the tape is covered with a protective film, the protective film may also be provided with the creases or score lines, such that each segment or sachet is covered with a protective film and may be separated from the bulk tape whilst protective film remains covering the segment or sachet.

When the kneadable adhesive sealant composition is provided as one or more longitudinal envelopes of a first material and a second material enclosed within the envelope of the first material surrounded by the first material, the one or more longitudinal envelopes may preferably be attached to one another, preferably in a parallel end-to-end arrangement or a parallel side-by-side arrangement, or both to form a sheet of envelopes. The envelopes may be attached by a thin strip of the first material. This allows easy separation of the envelopes of the kneadable adhesive sealant composition. This has the benefit of creating pre-portioned unit doses of the compositions, which may be selected by a user. Thus, each of the composition's one or more longitudinal envelopes may be considered a unit dose of said precursor. This thin strip of material may be a perforated or otherwise weakened to aid separation of the segments by a user of the composition.

Preferably, the one or more envelopes are provided in a series of at least two, at least three, at least four, at least five, at least 10 envelopes preferably arranged end to end so as to form a tape of the kneadable adhesive sealant composition comprising a number of easily separable unit doses.

When the kneadable adhesive sealant composition (preferably where the composition is a tape) is provided with the segment, sachets or envelopes disclosed above, this enables production of unit dose of the kneadable adhesive sealant composition, where the inner second material is protected from air exposure. These can be produced simply and without the use of an additional packaging component. Thus, the invention may reduce packaging waste and complexity while also allowing easy changes to the length of the individual pieces by adjusting the repeat distance of the creases or scores. Provision of a kneadable adhesive sealant composition comprising a number of different length unit doses within a single kneadable adhesive sealant composition is also envisaged. This provides greater flexibility to the user.

A process for producing a kneadable adhesive sealant composition of the invention, comprises:

providing a first material comprising an uncured reactive polymer or resin composition and a second material comprising a curing agent capable of curing the uncured reactive polymer or resin composition, wherein the curing agent when combined with the uncured reactive polymer or resin composition forms a substantially homogenous mixture;

co-extruding the first and second materials to form a kneadable adhesive sealant composition, comprising:

a first (outer) longitudinal portion of the first material; and

a second (inner) longitudinal portion of the second material;

wherein the first longitudinal portion substantially surrounds the second longitudinal portion along the length of the second longitudinal portion;

wherein, on kneading the composition to form a substantially homogenous mixture, the first and second materials react to cure the polymer or resin composition, and thereby form an adhesive sealant.

The first and second materials may be co-extruded to form the kneadable adhesive sealant composition of the invention using any extrusion technique known in the art, for example as disclosed in U.S. Pat. No. 3,837,981 and G.B. Patent No. 2,097,401. Preferably, the first and second materials are co-extruded to form a kneadable adhesive sealant composition using a screw extruder. An extruder die may be selected to control the size of the cross-sectional area of the composition. Preferably, the die has a circular internal cross section (referred to herein as a circular die), which may be used to form a cylindrical composition. Alternatively, the die may have a rectangular cross section, or any other suitable shape. As would be appreciated by a skilled person, a die insert may be used to provide the internal cross section of the die. The internal cross-section of the die (or die insert) provides the shape of the extruded kneadable adhesive sealant.

The process may further comprise the step of covering the extruded kneadable adhesive sealant with a protective coating, film or casing as described herein.

Once the required length of composition has been extruded, the extruded composition may be cut to produce the desired length of the kneadable adhesive sealant composition. The composition may be cut, for example, using a fly wheel or rotary cutter.

Where it is desired to produce a kneadable adhesive sealant composition in the form of a tape, the process may further comprise the step of flattening the extruded composition to form a tape. For example, the composition may be extruded in the form of a cylinder as described herein and then flattened, with e.g. a flattening roller.

Alternatively, in a particularly advantageous embodiment, the composition may be extruded through a die having a rectangular internal cross section to form a tape without the need for further flattening. This avoids the need to apply mechanical forces post extrusion.

The process may further comprise the step of making one or more lateral creases, scores or cuts along the length of the kneadable adhesive sealant to divide the kneadable adhesive sealant into two or more segments, sachets or envelopes, as described herein. The creases, scores or cuts may be made using a die, press or roller cutter, with any blade orientation to provide the segment size that may be desired by the user. The position of the blades in the cutter may be varied by the user, such that the repeat distance (where more than two creases, scores or cuts are made) of the creases, scores or cuts is varied. For example, a kneadable adhesive sealant composition tape could be provided with multiple sized segments using a die cutter with an asymmetric blade orientation.

The creases or scores may preferably be such that a thin layer of the first material remains between the segments to keep them attached to one another. This forms a kneadable adhesive sealant composition, comprising two or more longitudinal envelopes of the first material with the second material provided within the envelope surrounded by the first material, for example in accordance with the second aspect of the invention. By varying the repeat distance of the creases or scores, a kneadable adhesive sealant composition comprising a number of different length unit doses may be provided. For example, the segments or envelopes may have lengths independently from about 10 to about 10 to about 200 mm, preferably about 25 to about 100 mm.

The combination of a kneadable adhesive sealant composition having creases, scores or cuts is particularly advantageous when the kneadable adhesive sealant composition is a tape.

To use the adhesive sealant precursor composition of this invention, a portion of the composition, preferably comprising substantially equal lengths (where stoichiometry allows) of the first material and the second material, is selected and the first and second materials are mixed (i.e., kneaded) together.

When the kneadable adhesive sealant composition of this invention is used to form an adhesive sealant, the resulting putty-like adhesive sealant may have a relatively short shelf life, and should therefore be used rather promptly, as substantial curing may be effected at room temperature within about ten minutes from the time when the uncured reactive polymer or resin composition and the curing agent are combined to form a substantially homogenous mixture. There must be a convenient period, after mixing by hand, during which the product remains workable for its intended application. Accordingly, the product is typically formulated so that substantial curing to the point of unworkability by hand occurs does not occur for up to about 30 minutes from initial mixing, and typically occurs in about 5 to about 30 minutes, preferably about 5 to about 10 minutes, from the time of mixing. This point can be characterized by a Durometer hardness (Shore A) of at least 10. The product may reach a Shore A of at least 60 within 10 minutes from time of mixing, and thus may be an extremely rapid, room temperature curing adhesive sealant. The Durometer hardness may be measured using a PTC Instruments Model 306L Shore A Durometer as set out in ASTM D2240. For example, hardness can be measured by pressing the durometer against the surface of the sample so the needle is impressed into the surface. The distance the needle travels into the surface is related to the dial reading. The reading may be taken while pressing the meter against the surface for 5 seconds.

Mixtures formed from precursor compositions according to this invention may preferably substantially cure within about 30 minutes minutes or less from the time of initial mixing of the first and second materials to a useful, tough, solid, adhesive. The adhesive formed from the composition has excellent adhesive-sealant properties, and may be utilised to adhere a wide variety of materials, for example stone, ceramic, wood, metal and like materials; and/or or for the repair or maintenance of a wide variety of surfaces, for example stone, ceramic, wood, metal and the like. The composition may advantageously cure under water, making it useful in marine environments.

Embodiments are now described by way of non-limiting example to illustrate aspects and principles of the disclosure, with reference to the accompanying drawings.

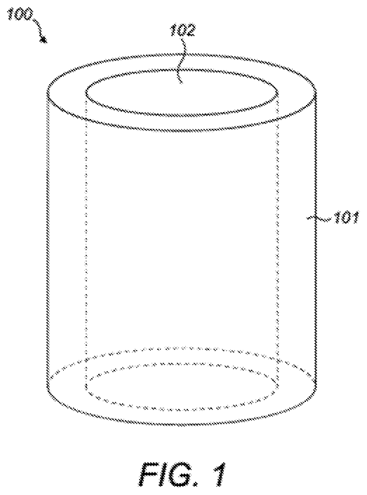

FIG. 1 shows a side view cylindrical stick of a kneadable adhesive sealant composition of the invention.

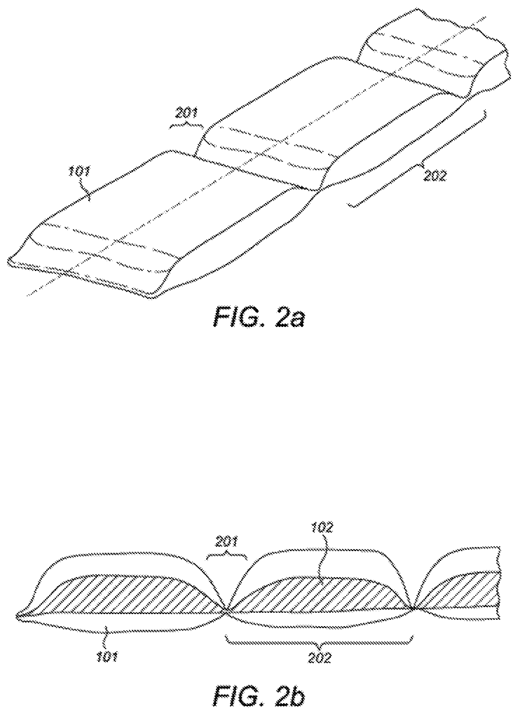

FIG. 2 shows a) a side view of a tape of kneadable adhesive sealant composition of the invention; and b) a cross section of the tape taken along the dotted line in FIG. 2 a).

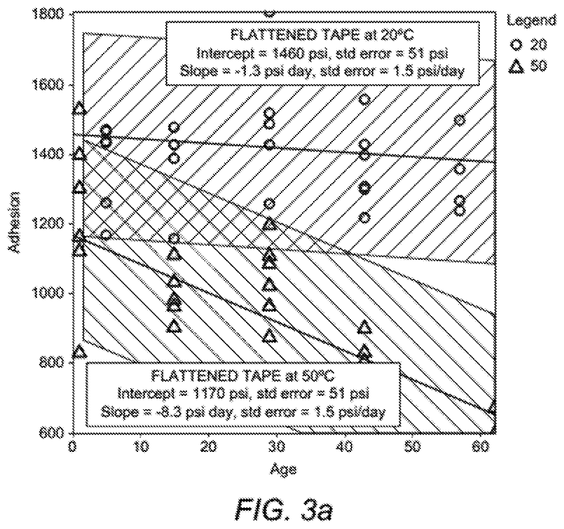

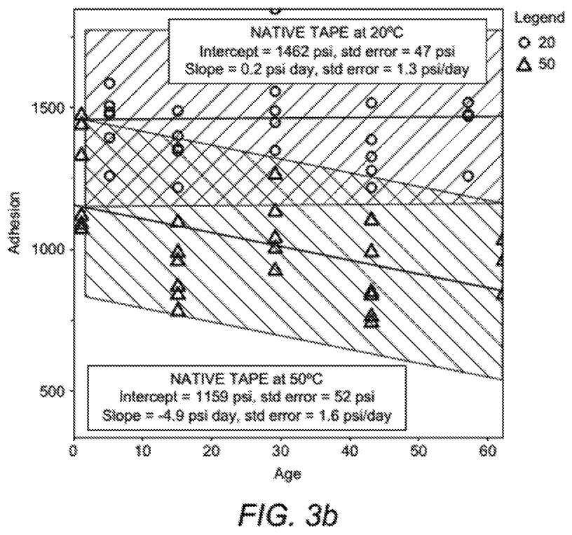

FIGS. 3a and 3b are graphs showing the adhesion performance of kneadable adhesive sealant compositions, with storage of the compositions over time.

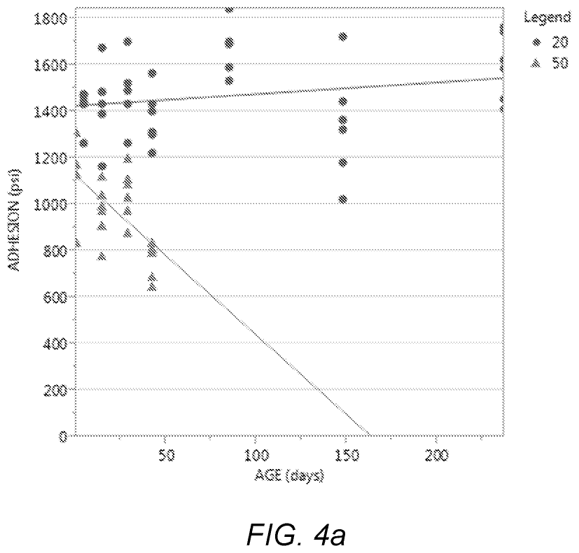

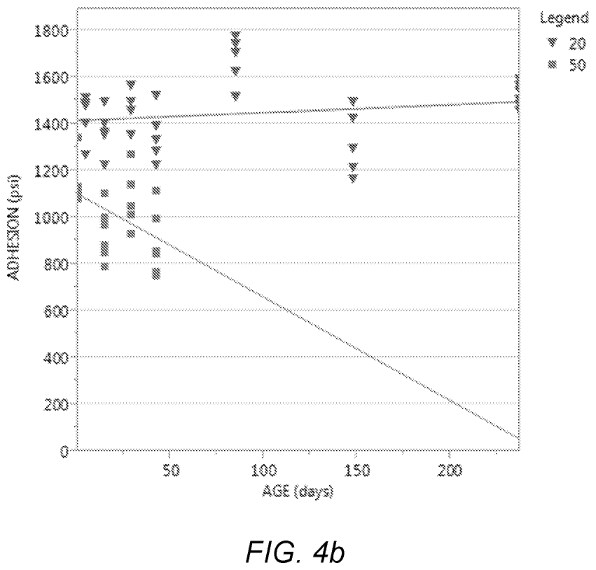

FIGS. 4a and 4b are graphs showing the adhesion performance of kneadable adhesive sealant compositions, with storage of the compositions over time.

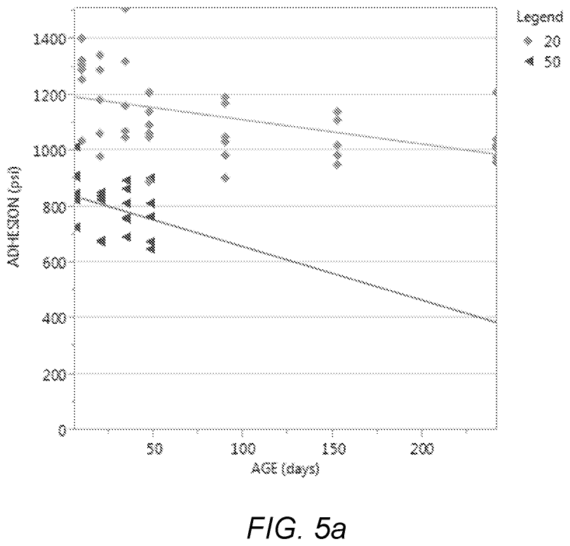

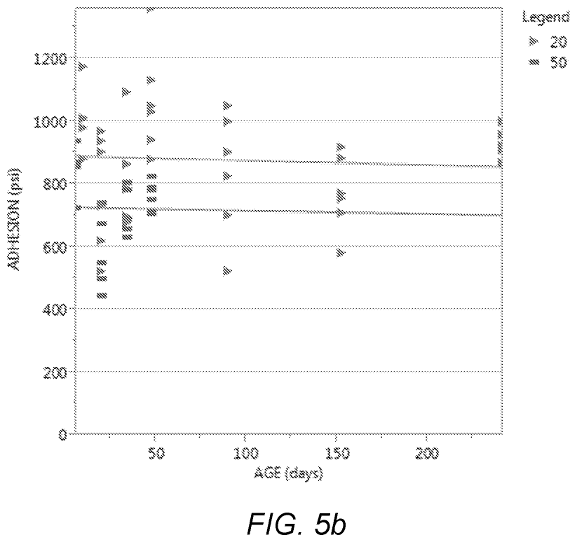

FIGS. 5a and 5b are graphs showing the adhesion performance of kneadable adhesive sealant compositions, with storage of the compositions over time.

With reference to FIG. 1, there is provided a kneadable adhesive sealant composition 100 provided as a cylindrical stick. The kneadable adhesive sealant is extruded through a circular die. The first longitudinal portion of a first material 101 is provided radially outward of the second longitudinal portion of a second material 102, such that the longitudinal portion of the second material is surrounded along its length by the longitudinal portion of the second material. This arrangement protects the air-sensitive second material from the air.

With reference to FIG. 2, there is provided kneadable adhesive sealant composition 200 provided as a tape having lateral creases 201 along the length of the tape to divide the tape into a number of segments or envelopes 202. FIG. 2 a) shows kneadable adhesive sealant composition 200 as extruded through a circular die and flattened by passing through a flattening roller to produce a tape. Alternatively, the kneadable adhesive sealant composition 200 may be extruded through a rectangular die to avoid the need for flattening. The longitudinal portion of the first material 101 surrounds the longitudinal portion of the second material 102 in the tape form and provides an outer layer to the tape.

FIG. 2 b) shows a cut through taken along the dotted line of FIG. 2 a) and illustrates the arrangement with the band of the first material 101 surrounding the band of the second material 102.

Sample Manufacture

Exemplary Manufacture Protocol

A two-part kneadable adhesive sealant composition according to the invention comprising a first material comprising an uncured reactive polymer or resin composition and a second material comprising an agent capable of polymerising or curing the uncured reactive polymer or resin composition may be produced using an extruder (for example, a screw extruder as sold by The Bonnot Company). Piston or ram extruders could also be used to produce the kneadable adhesive sealant composition.

The first material comprises between 35 and 50 wt % talc filler, up to 25 wt % silicon dioxide microspheres filler, between 5 and 35 wt % bisphenol-A-(epichlorohydrin) epoxy resin (having number average molecular weight of 700 Da), up to 5 wt % titanium dioxide, and up to 2.5 wt % di-isodecyl phthalate.

The second material comprises between 10 and 80 (preferably about 10 to about 60) wt % of a polymercaptan epoxy hardener, between 35 and 50 wt % talc filler, up to 25 wt % silicon dioxide microspheres filler, up to 1 wt % 3,6-diaxaoctanethylenediamine, between 0.1 and 15 wt % (preferably 0.5 and 3 wt %) aminophenol or 2,4,6-tris(dimethylaminomethyl)phenol and up to 2.5 wt % di-isodecyl phthalate.

The first and second materials were coextruded through a rectangular die head resulting in a two component concentric co-axial tape composition. The composition was extruded onto a protective barrier plastic film. The extruded composition was cut using a Flywheel Cutter (Goodman). A second layer of protective film was applied on top of the extruded composition. Product was then chilled to below about 10° C. to improve handling and finishing.

The composition and protective film were then scored using a die cutter to form perforated strips creating a sheet of attached individual use segments of the composition, which was then further cut to a predetermined finished length for packaging.

Stability of Kneadable Adhesive Sealant

The following experiment quantifies the degradation rate of the kneadable adhesive sealant composition of the present invention compared with co-extruded epoxy tapes known in the art. Lap shear adhesive strength was chosen to measure of the effects of temperature and aging on the degradation of the kneadable adhesive sealant composition. Lap shear adhesion is a primary performance character of adhesive systems and is sensitive to commonly encountered manners of degradation.

Sample Manufacture

Two sets of kneadable adhesive sealant compositions according to the invention were studied (the formulations BLUE TAPE 1 and BLUE TAPE 2). A batch of each of the first and second materials was made in a double arm kneader mixer. The same batches of materials were used to make all samples of the invention by co-extrusion using different die configurations to form kneadable adhesive sealant compositions of different dimensions.

To make a kneadable adhesive sealant compositions, a batch of each of the first and second materials was fed into the same co-extrusion system. Two different die configurations were used. The first die was a nominally 12.5 millimeters (mm) diameter circle and the second was a nominally 20 mm wide by 5 mm high rectangle.

The rectangular die was attached to the extrusion system to produce kneadable adhesive sealant compositions of substantially one dimension without any additional downstream shaping. This product is referred to in the following as the NATIVE TAPE.

The circular die was also used for the purpose of illustrating the invention. With the circular die, kneadable adhesive sealant compositions were as a cylinder of nominally 12.5 mm diameter. The cylindrical extrudate through a flattening roller, creating a nominally 20 mm wide tape. This product is referred to in the following as the FLATTENED TAPE.

Sample Conditioning

After preparation, the NATIVE TAPE products were stored in ambient lab conditions (20° C.±2° C.). Additionally a sample of each of these was stored in a 50° C. oven for the duration of the experiment. The products stored under ambient conditions and in the oven were evaluated within one week of manufacture and then every two weeks thereafter.

Preparation of Test Bonds

Samples were taken from each of the products for analysis by cutting across the product in cross section using a razor blade. Each sample was mixed by kneading until the material attained a uniform color, and then for an additional minute. The mixed sample was then used to create two overlap bonds between two metal test panels provided by Q-Labs measuring nominally 100 mm by 25 mm by 1.5 mm. The test panels were cleaned with isopropyl alcohol and wiped with a lint free cloth. The mixed sample was applied to one end of the brushed finish side of each test panel. Two pieces of AWG 24 steel wire nominally 3 mm in length were embedded in the product that was applied to one of the panels. The other panel was pressed overtop to create an overlap bond. Bonds were clamped in place using two Pony 3201 One-Inch Steel Spring Clamps. During the clamping process, any excess product was squeezed out of the bond and discarded. This bond construction created a nominal 25 mm by 12.5 mm bond with a thickness of 0.5 mm. The time that each test specimens was completed was recorded.

Each product to be investigated was sampled three times, and each specimen was used to create two bonds. Six total bonds were created for each of the ambient conditions-stored products and the oven-stored products.

Evaluation of Test Bonds

After 24±2 hours of curing at ambient conditions (20° C.±2° C.), the bond strength of bonded sample was evaluated, using a Tineous Olsen H25KS universal testing frame using a load cell with a 5000 pound-force capacity. The samples were evaluated in accordance with ASTM method D1002 with a specific cross-head speed of 0.05 inches per minute. Sample bonds were pulled in tensile stress until failure. The ultimate stress observed was recorded as the bond strength.

Analysis of Data

The data collected was analyzed to determine the rate of degradation at of the products stored at ambient conditions and in the 50° C. oven. The degradation model shown assumes a linear relationship between performance and age. This model is described below:

In the simplest case, the rate of degradation is constant with time.

$$\frac{d y}{dt} = k ;$$

Where y is the performance character to be investigated (in this case adhesion), t is time, and k is a constant.

Since the compositions can have a useful life of many years and the room temperature rate degradation may not be linear, it can take an undesirably long time to determine the degradation rate with the desired degree of accuracy. In most cases, the rate constant is a function of temperature. In some cases, the reaction rate k follows an Arrhenius behavior:

$$k = A {e}^{\frac{- {E}_{a}}{R T}}$$

Where A is a pre-exponential factor, Ea is an activation energy, R is the gas law constant, and T is the absolute temperature.

Using this relationship, the degradation rate at higher temperatures can be used to improve the accuracy of the ambient temperature degradation rate. In such a case the degradation study is carried out in an iterative manner and experiments conducted until enough data is collected to accurately model the degradation.

The results of the study are shown in FIGS. 3a and 3b. In the case of BLUE TAPE 1, the degradation rate at 50° C. (heat accelerated aging) for the NATIVE TAPE (FIG. 3b) is 4.9 psi of adhesive strength per day compared to a rate of 8.3 psi per day for the FLATTENED TAPE (FIG. 3a).

The average bond adhesion observed over time shows that kneadable adhesive sealants made from kneadable adhesive sealant compositions of the invention of the NATIVE TAPE kind degrade at a slower rate. Specifically, in the case of BLUE TAPE 1, these average degradation rates show the adhesive sealants made from the NATIVE TAPE are 40% more stable. The data for BLUE TAPE 2 shows similar trends.

Extended Aging

The average bond adhesion for both the BLUE TAPE 1 and BLUE TAPE 2 formulations were observed over a longer period of time and these results are shown in FIG. 4 for BLUE TAPE 1 (FIG. 4a—FLATTENED TAPE; FIG. 4b—NATIVE TAPE) and FIG. 5 for BLUE TAPE 1 (FIG. 5a—FLATTENED TAPE; FIG. 5b—NATIVE TAPE).

In the case of BLUE TAPE 1, the NATIVE TAPE showed a 35% improvement in degradation rate at 50° C. (heat accelerated aging) and 32% at 20° C. compared with the FLATTENED TAPE (Table 1).

TABLE 1

| | BLUE TAPE 1 | | | | | | |
|---|---|---|---|---|---|---|---|
| | FLATTENED (psi/day) | | | NATIVE (psi/day) | | | |
| | AVERAGE | | | AVERAGE | | | |
| T (° C.) | RATE | lower | upper | RATE | lower | upper | Improvement |
| 20 | 0.5 | −0.16 | 1.61 | 0.34 | −0.2 | 0.87 | 32% |
| 50 | −6.87 | −11.67 | −2.06 | −4.44 | −8.4 | −0.48 | 35% |

In the case of BLUE TAPE 2, the NATIVE TAPE showed a 95% improvement in degradation rate at 50° C. (heat accelerated aging) and 84% at 20° C. compared with the FLATTENED TAPE (Table 2).

TABLE 2

| | BLUE TAPE 2 | | | | | | |
|---|---|---|---|---|---|---|---|
| | FLATTENED (psi/day) | | | NATIVE (psi/day) | | | |
| | AVERAGE | | | AVERAGE | | | |
| T (° C.) | RATE | lower | upper | RATE | lower | upper | Improvement |
| 20 | −0.87 | −1.32 | −0.42 | −0.14 | −0.94 | 0.65 | 84% |
| 50 | −1.92 | −4.86 | 1.02 | −0.1 | −1.7 | 1.49 | 95% |

Throughout the description and claims of this specification, the words “comprise” and “contain” and variations of the words, for example “comprising” and “comprises”, mean “including but not limited to”, and are not intended to (and do not) exclude other components.

It will be appreciated that variations to the foregoing embodiments of the invention can be made while still falling within the scope of the invention. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

It will be appreciated that many of the features described above, particularly of the preferred embodiments, are inventive in their own right and not just as part of an embodiment of the present invention. Independent protection may be sought for these features in addition to or alternative to any invention presently claimed.

While preferred embodiments of the present invention have been shown and described herein, it will be apparent to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention and that methods and structures within the scope of these claims and their equivalents be covered thereby.

1. A kneadable adhesive sealant composition, comprising:
a first, outer, longitudinal portion of a first material; and
a second, inner, longitudinal portion of a second material;
wherein the first longitudinal portion substantially surrounds the second longitudinal portion along the length of the second longitudinal portion;
wherein the first material comprises an uncured reactive polymer or resin composition and the second material comprises a curing agent capable of curing the uncured reactive polymer or resin composition; and
wherein, on kneading the composition to form a substantially homogenous mixture, the first and second materials react to cure the polymer or resin composition, and thereby form an adhesive sealant.

2. The kneadable adhesive sealant composition of claim 1, wherein the curing agent is present in an amount sufficient to cure from about 50 to about 150% of the uncured reactive polymer or resin composition.

3. The kneadable adhesive sealant composition of claim 1 or 2, wherein the longitudinal portion of the first material and/or the second material have a circular, elliptical, rectangular or square cross-section.

4. The kneadable adhesive sealant composition of any preceding claim, wherein the longitudinal portion of the first material and the longitudinal portion of the second material each have a cross-section having an area of about 10 mm² to about 500 mm².

5. The kneadable adhesive sealant composition of any preceding claim, wherein the width of the kneadable adhesive sealant composition is about 5 mm to about 50 mm.

6. The kneadable adhesive sealant composition of any preceding claim, wherein the kneadable adhesive sealant composition is provided as a tape.

7. The kneadable adhesive sealant composition of any one of claims 1-5, wherein the kneadable adhesive sealant composition is provided as a stick.

8. The kneadable adhesive sealant composition of any preceding claim, wherein the kneadable adhesive sealant composition is surrounded by a protective coating, casing or film.

9. The kneadable adhesive sealant composition of any preceding claim, wherein the uncured reactive polymer or resin composition comprises an uncured epoxy resin.

10. The kneadable adhesive sealant composition of any preceding claim, wherein the curing agent comprises a polymercaptan amine curing agent.

11. The kneadable adhesive sealant composition of any preceding claim, wherein one or more lateral creases or scores (optionally perforated) are provided along the length of the kneadable adhesive sealant composition to divide the kneadable adhesive sealant composition into two or more segments,

12. The kneadable adhesive sealant composition of claim 11, wherein:
a) the creases or scores are regularly spaced such that each segment has substantially the same shape; or
b) the creases or scores are irregularly spaced such that more than one shape of segment is present.

13. A kneadable adhesive sealant composition, comprising:
one or more, outer, envelopes of a first material; and
a second, inner, material enclosed within the one or more envelopes of the first material surrounded by the first material;
wherein the first material comprises an uncured reactive polymer or resin composition and the second material comprises a curing agent capable of curing the uncured reactive polymer or resin composition; and
wherein, on kneading the composition to form a substantially homogenous mixture, the first and second materials react to cure the polymer or resin composition, and thereby form an adhesive sealant.

14. The kneadable adhesive sealant composition of claim 13, comprising the features of any one of claims 2 to 10.

15. The kneadable adhesive sealant composition of claim 13 or 14, wherein the kneadable adhesive sealant composition is provided as a tape.

16. The kneadable adhesive sealant composition of any one of claims 13 to 15, wherein the composition comprises two or more, outer, envelopes of the first material.

17. The kneadable adhesive sealant composition of claim 16, wherein:
a) each envelope has substantially the same shape; or
b) more than one shape of envelope is present.

18. A process for producing a kneadable adhesive sealant composition, comprising:
providing a first material comprising an uncured reactive polymer or resin composition and a second material comprising a curing agent capable of curing the uncured reactive polymer or resin composition; and
co-extruding the first and second materials to form the kneadable adhesive sealant composition of any one of claims 1 to 17.

19. The process of claim 18, wherein the first and second materials are co-extruded using a screw extruder.

20. The process of claim 18 or 19 where the process further comprises the step of covering the extruded kneadable adhesive sealant composition with a protective coating, casing or film.

21. The process of any one of claims 18 to 20, wherein the first and second materials are co-extruded through a die having a rectangular cross-section to form a kneadable adhesive sealant composition provided as a tape.

22. The process of any one of claims 18 to 21, further comprising the step of flattening the kneadable adhesive sealant composition to form a tape.

23. The process of any one of claims 18 to 22, further comprising the step of making one or more lateral creases or scores along the length of the kneadable adhesive sealant composition, to divide the kneadable adhesive sealant composition into two or more segments.

24. Use of the kneadable adhesive sealant composition of any one of claims 1 to 18 as an adhesive or in the maintenance or repair of a surface, for example a stone, ceramic, metal, wood or plastics surface.

25. A kneadable adhesive sealant composition, process or use as substantially described herein with reference to or as illustrated in one or more of the examples or accompanying figures.
